(19) United States
(12) Patent Application Publication
(10) Pub. No.: US 2005/0134140 A1
(43) Pub. Date: Jun. 23, 2005

(54) Motor mounting base

(75) Inventor: Jesus Fernandez-Grandizo Martinez, Mexico City (MX)

Correspondence Address: WILDMAN HARROLD ALLEN & DIXON, 225 WEST WACKER DRIVE, SUITE 2800, CHICAGO, IL, 60606, US

(73) Assignee: Koblenz Electrica, S.A. DE C.V.

(21) Appl. No.: 11/056,842

(22) Filed: Feb. 11, 2005

Related U.S. Application Data
(63) Continuation of application No. 10/072,200, filed on Feb. 7, 2002.

(51) Int. Cl. H02K 13/00

(52) U.S. Cl. 310/239

(57) ABSTRACT

A motor mounting platform for use in an appliance, such as a vacuum cleaner, is constructed of a first material and at least two brush holders, which are constructed of a second material, are engaged to the motor mounting platform. At least one motor support and at lest two pair of brush holder guides are mounted to the motor mounting platform. Each pair of brush holder guides receivably engages the brush holders and are adapted to permit the brush holders to be removed from the motor mounting platform.

### CROSS-REFERENCE TO RELATED APPLICATIONS

This application is a continuation of prior application Ser. No. 10/072,200, filed Feb. 7, 2002.

### FIELD OF THE INVENTION

The invention involves a motor mounting platform in general, and in particular, a motor mounting platform that utilizes commutator brush holders.

### BACKGROUND OF THE INVENTION

The mounting of the motor within an electrical appliance such as vacuum cleaner requires a manufacture to satisfy various safety requirements. This is because as the power source for the appliance, the motor generates electrical current that must be insulated from other components in order to prevent the risk of fire.

Currently, motors are mounted in electrical appliances through the use of mounting platforms that utilize commutator brush holders that are integrally molded with the mounting base. Furthermore, the current carrying parts of the brush holders may be retained to the mounting base through the use of screws or the like. The mounting base and motor are then assembled on top of the fan cavity or, in some designs, inserted and secured with screws on a big center opening of the fan cavity.

Since the current carrying components are directly supported on the motor base, in order to comply with international safety requirements, the thermoplastic material used for the base must have a high temperature classification and self-extinguishing properties. Such materials are rather expensive and thus increase the cost of manufacturing a small appliance. This in turn drives up the cost of the final product.

Given the safety standards that must be met in order to obtain product certification on a worldwide basis, a motor mounting platform that allows a motor to be mounted in a small appliance while, at the same time, allowing all electrical carrying components to be displaced from the mounting platform, thereby eliminating the need for high cost thermoplastics would be an important improvement in the art.

### SUMMARY OF THE INVENTION

The invention involves a motor mounting platform for use in an appliance, such as a vacuum cleaner. The motor mounting platform is constructed of a first material and at least two brush holders, which are constructed of a second material, are engaged to the motor mounting platform. At least one motor support and at lest two pair of brush holder guides are mounted to the motor mounting platform. Each pair of brush holder guides receivably engages the brush holders and are adapted to permit the brush holders to be removed from the motor mounting platform.

The invention also involves a motor mounting platform that is constructed of a first material and at least two brush holders, which are constructed of a second material, are engaged to the motor mounting platform. At least one motor support is integrally molded with the motor mounting platform.

### BRIEF DESCRIPTIONS OF THE DRAWINGS

FIG. 1 is a top plan view of the motor mounting platform.

FIG. 2 is a sectional view taken along line 2-2 of the brush holder guides as seen in FIG. 1.

FIG. 3 is a sectional view taken along line 3-3 of the motor mounting platform as seen in FIG. 1.

FIG. 4 is a bottom plan view of the motor mounting platform.

FIG. 5 is a top plan view of the motor mounting platform showing a motor mounted on the platform.

FIG. 5A is a sectional view taken along line 5A, as seen in FIG. 5.

FIG. 6 is a sectional view taken along line 6-6, as seen in FIG. 5.

FIG. 7 is an exploded perspective view showing a commutating brush, brush holder and a partial cut-away of the motor mounting platform showing the brush holder guides, guide slots and stop bar.

FIG. 8 is a partial cut-away side elevation of the assembled brush holder as seen in FIG. 7.

FIG. 9 is a partially assembled perspective view of the brush holder assembly as seen in FIG. 7.

FIG. 10 is a rear view of a fully assembled brush holder assembly as seen in FIG. 7.

### DETAILED DESCRIPTION OF THE INVENTION

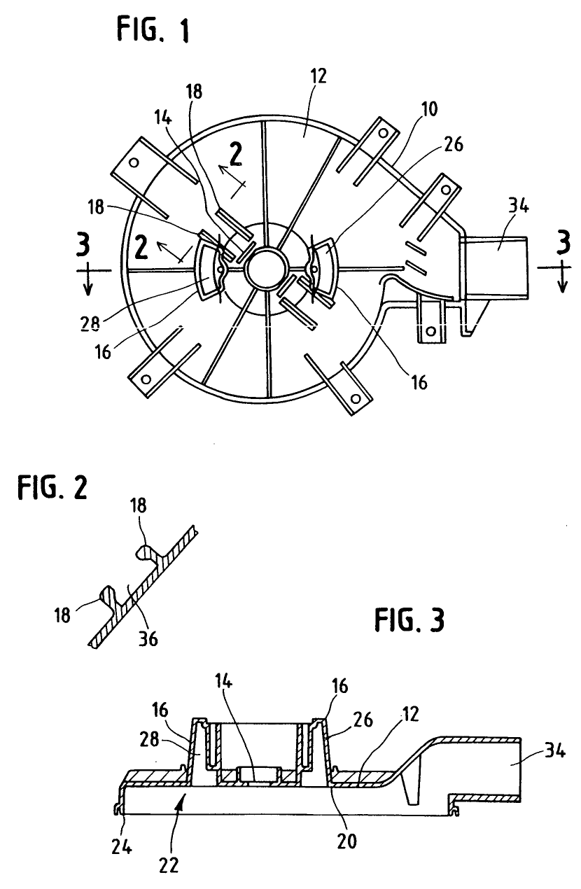

The invention involves a motor mounting platform 10 for use in a small appliance such as a vacuum cleaner. As shown in FIGS. 1, 3, 5 and 6, the motor mounting platform 10 is constructed of a first material and comprised of at least two brush holders 20, constructed of a second material, removably engaged to the platform 10. The second material is electrically non-conductive. In addition, the first material could have a lower thermal classification than the second material. For example, the first material, the material used to manufacture the mounting platform, may have a thermal classification as low as Underwriters Laboratories' UL-94-HB.

The platform 10 includes at least one motor support 16 mounted to the platform 10, at least two pair of brush holder guides 18 mounted directly to the platform 10 and at least two brush holders 20 constructed of electrically non-conductive material, removably engaged to the platform 10 within the brush holder guides 18, whereby all electrical carrying components are displaced from the mounting platform 10.

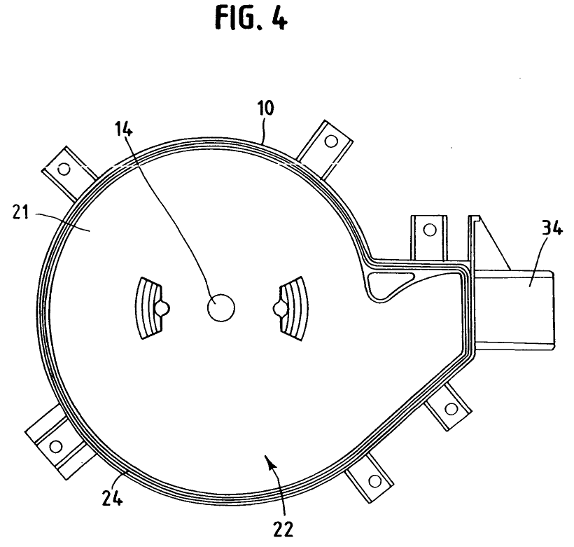

The motor mounting platform 10 has a first side 12 and a second side 21. The second side 21 includes a cavity 22 surrounded by a wall 24. The motor support 16 and the brush holder guides 18 are mounted on the first side 12. Cavity 22 has an involute shape, as shown in FIG. 4.

The motor support 16 includes a first post 26 and a second post 28. These first and second posts 26, 28 may be mounted opposite of each other around a hole 14 extending through the platform 10.

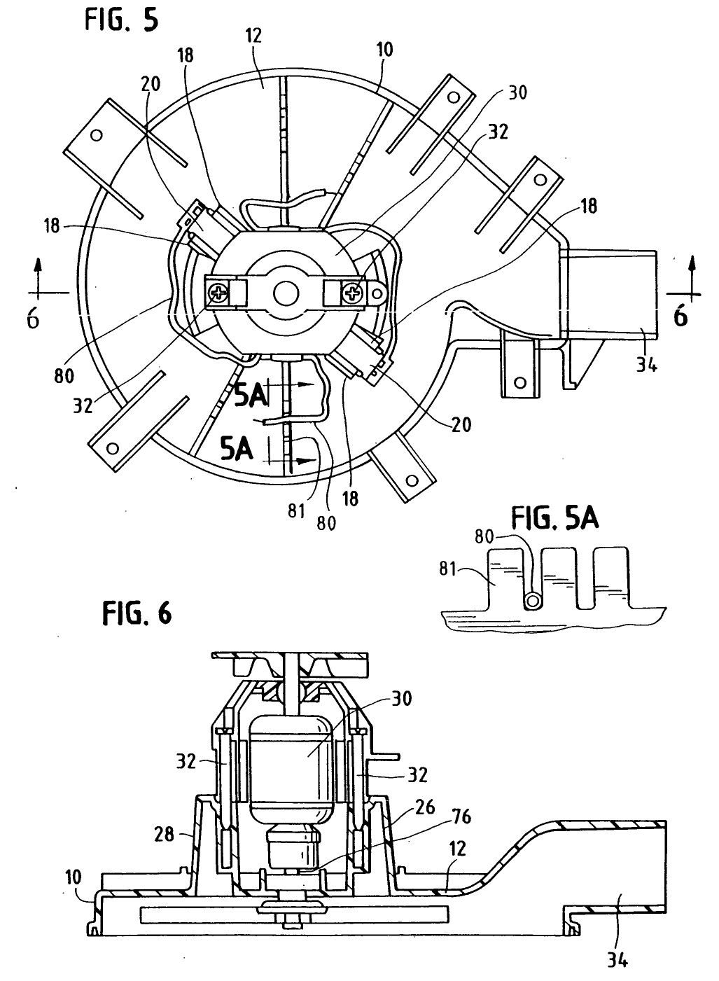

When in use, as shown in FIGS. 5 and 6, a motor 30 is attached to the first and second posts 26, 28 in such a manner that the attachment points 32 of the motor 30 to the support posts 26, 28 are displaced from the surface 12 of the mounting platform 10. This means, for example, that the motor 30 could be mounted on the tops of the first and second posts 26, 28. Such an attachment allows the mounting platform 10 to be free of any direct electrical contact with any components carrying electrical current. Motor 30 is attached to the at least one motor support 16 in such a manner that the mounting platform 10 is free of any direct contact with any electrical carrying components.

The inventive motor mounting platform 10 may also include an exhaust outlet 34 that extends from the mounting platform 10. This exhaust outlet 34 may be integrally molded with the mounting platform 10.

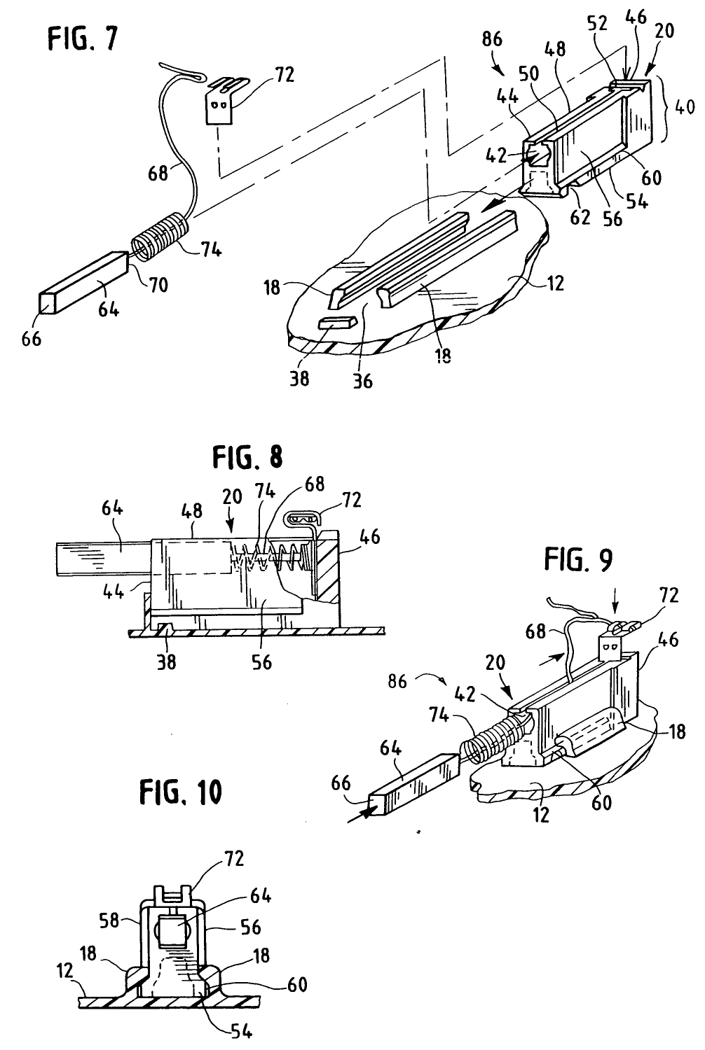

The pairs of brush holder guides 18 are mounted on opposite sides of the hole 14 extending through the platform 10. As shown in FIG. 2, the guides 18 may be comprised of a pair of inverted L-shaped guides, with each guide 18 opposing the other so as to form a slot 36 between them. A stop bar 38, as shown in FIG. 7, capable of engaging a brush holder 20 is also mounted on the platform 10 between each guide slot 36 and the hole 14.

The brush holders 20, as shown in FIGS. 7-10, are comprised of a housing 40 having an opening 42 running lengthwise between a first end 44 and a second end 46, a top side 48 including a first slot 50 in communication with the opening 42 and a second slot 52 in communication with the opening 42 and perpendicular to the first slot 50, a bottom side 54 opposite the top side 48 and a first side 56 and a second side 58 opposite of each other and perpendicular to both the first and second ends 44, 46 and the top and bottom sides 48, 54.

Although the housing 40 may have any one of several geometric shapes, in a typical brush holder 20 the housing 40 is rectangular in that the first side 56 and the second side 58 of the housing 40 are of a first length, the first end 44 and the second end 46 are of a second length and the first length is longer than the second length. Such a housing 40 may also have a top side 48 having a first width and a bottom side 54 having a second width with the second width being greater than the first width. The first and second sides 56, 58 of the brush holder 20 also include a bottom edge 60 adapted to be positioned within the inverted L-shaped guides 18. The bottom side 54 also includes a notch 62 capable of engaging the stop bar 38.

The brush holder housing 40 encloses a commutating brush 64 which is positioned within the opening 42 in the housing 40. One end 66 of the commutating brush 64 extends from the first end 44 of the housing 40 while a wire 68 extends from the second end 70 of the brush 64 to a lead or terminal 72 positioned adjacent to the second end 46 of the brush holder 20. A spring 74 encircling the wire 68 is positioned between the second end 70 of the commutating brush 64 and the second end 46 of the housing 40. This spring 74 allows the brush 64, which may be made of any suitable material including, for example, carbon, to remain in contact with the commutator 76 of the motor 30 throughout the life of the brush 64 (i.e., as the brush 64 wears down).

When in operation, the brush holder 20 is slid along the first side 12 of the motor mounting platform 10 in the slot 36 between the guides 18. The bottom edge 60 of the first and second sides 56, 58 of the housing 40 mate with the upper portion of the guides 18 in order to prevent the brush holder 20 from being lifted up out of the slot 36. The stop bar 38 momentarily interrupts the forward motion of the brush holder 20 sliding in the slot 36. This interruption is overcome, however, by applying extra pressure to the brush holder 20 thereby causing the holder 20 to pass over the stop bar 36 until the bar 36 engages the notch 62 on the bottom side 54 of the housing 40. This engagement prevents the brush holder 20 from backing out of the slot 36.

Once the brush holder 20 is in position, the commutating brush 64 located in the brush holder 20 is in contact with the commutator 76 of the motor 30 which is mounted on the motor support 16 that is connected to the mounting platform 10. As the commutator 76 rotates, an electrical current is transmitted through the commutating brushes 64 and the wire 68 extending from the second end 70 of the brush 64 to the lead 72 located in the brush housing 40. This electric current is then transmitted through wires 80 connected to the lead 72.

Because the commutating brush 64, wire 68 and lead 72 are all enclosed in the brush housing 40, no component carrying electrical current is in direct contact with the motor mounting platform 10. This arrangement allows the mounting platform 10 to be constructed of less expensive material having a lower thermal classification.

The motor support 16 allows the attachment point(s) 32 of the motor 30 to be displaced from the mounting platform 10. This too allows for the motor 30 to be mounted to the motor mounting platform 10 without having any electrical current carrying components in contact with the mounting platform 10.

The motor support 16 and the guides 18 may be integrally molded with the mounting platform 10. Furthermore, the motor support 16 may be in contact with the guides 18.

Wire guides 81 may be connected to the platform 10. These guides hold and retain in position the insulated electrical wires 80 running from the motor 30.

Because no components carrying electrical current are in direct contact with the motor mounting platform 10, the platform 10 may be made of a less expensive thermoplastic material without the need for special thermal classification. This results in great cost savings when compared to conventional motor mounting platforms that are known to be made of various materials including known thermoplastic materials that have a high temperature classification and self extinguishing properties.

The invention also involves a combination of a motor 30 mounted to a motor mounting platform 10 such that all electrical carrying components are displaced from the mounting platform 10. As discussed above, and shown in FIG. 5, the motor 30 has an opening with a shaft 82 extending therethrough and the motor mounting platform 10 is comprised of a platform 10 with a hole 14 extending therethrough, at least one motor support 16 mounted to the platform 10, at least two pair of brush holder guides 18 mounted directly to the platform 10, at least two brush holders 20 made of electrically non-conductive material, the at least two brush holders 20 removably engaged to the platform 10 within the brush holder guides 18.

The brush holders 20 are comprised of a commutating brush 64 positioned within an opening 42 in the brush holder 20, the commutating brush 64 having a first end 66 and a second end 70 with the first end 66 being capable of contacting a commutator 76 of a motor 30, a wire 68 located within the opening 42, the wire 68 attached to the second end 70 of the commutating brush 64, a spring 74 contacting the second end 70 of the commutating brush 64 and positioned between the second end 70 of brush 64 and the second end 46 of brush holder 20. The spring 74 encircling the wire 68. Wire 68 connects to terminal 72 located adjacent to the second end 46 of the brush holder 20 opposite the commutating brush 64.

In an embodiment of the invention, the commutating brush 64 is made of carbon.

The invention also involves an inventive method for manufacturing a commutator brush assembly 86 having a commutating brush 64 within a commutator brush holder 20. The method is comprised of the steps of: (a) providing a commutator brush holder 20 having an opening 42 between a first end 44 and a second end 46 in which the opening 42 receives a commutator brush 64 and a top side 48 having a first slot 50 therealong in communication with the opening 42; and (b) positioning a lead wire 68 for connecting to the commutator brush 64 through the first slot 50.

The method further comprises the steps of: (1) connecting a first end 90 of a lead wire 68 to a terminal lead 72; (2) encircling the lead wire 68 with a spring 74; (3) securing a second end 92 of the lead wire 68 to an end of the commutating brush 64; (4) placing the commutating brush 64 within the opening 42 at the first end 64 of the commutator brush holder 20 such that the lead wire 68 is aligned within the first slot 50; (5) sliding the lead wire 68 along the length of the first slot 50; and (6) securing the terminal lead 72 to the brush holder 20. In addition, a second slot 52 is provided in the top side 48, the second slot 52 being in communication with the opening 42 and perpendicular to the first slot 50 and the terminal lead 72 is secured within the second slot 52.

The inventive steps of the method could further comprise the step of sliding the lead wire 68 along the length of the first slot 50 until reaching the second slot 52, where the second slot 52 is adjacent to the second end 46 of the brush holder 20.

While the principles of the invention have been shown and described in connection with various embodiments, it is understood clearly that such embodiments are by way of example and are not limiting.

1. A motor mounting platform for use in an appliance comprising:
the motor mounting platform constructed of a first material;
at least two brush holders constructed of a second material being engaged to the motor mounting platform;
at least one motor support mounted to the motor mounting platform; and
at least two pair of brush holder guides mounted directly to the motor mounting platform in which each pair receivably engages the brush holders and is adapted to permit the brush holders to be removed from the motor mounting platform.

2. The motor mounting platform of claim 1 wherein each pair of brush holder guides comprises a pair of inverted L-shaped guides, each L-shaped guide opposing the other.

3. The motor mounting platform of claim 1 wherein a stop bar is mounted to the motor mounting platform between each pair of brush holder guides and proximate a hole which extends through the platform.

4. The motor mounting platform of claim 1 wherein the brush holder is comprised of:
a housing having an opening extending lengthwise between a first end and a second end;
a top side including a first slot in communication with the opening and a second slot in communication with the opening positioned perpendicular to the first slot;
a bottom side opposite the top side; and
a first side and a second side opposite of each other and perpendicular to both the first and second ends and the top and bottom sides.

5. The motor mounting platform of claim 4 wherein the first and second sides of the brush holder each have a bottom edge adapted to be positioned within a pair of brush holder guides.

6. The motor mounting platform of claim 4 wherein the bottom side includes a notch capable of engaging a stop bar.

7. The motor mounting platform of claim 1 wherein the at least one motor support and the brush holder guides are integrally molded with the motor mounting platform.

8. The motor mounting platform of claim 1 wherein the motor mounting platform is not in electrical contact with any current carrying component when the motor is attached to the at least one motor support.

9. A motor mounting platform for use in an appliance, comprising:
the motor mounting platform constructed of a first material;
at least two brush holders constructed of a second material being engaged to the motor mounting platform; and
at least one motor support integrally molded with the motor mounting platform.

10. The motor mounting platform of claim 9, further comprising at least two pair of brush holder guides mounted directly to the motor mounting platform in which each pair receivably engages the brush holders and is adapted to permit the brush holders to be removed from the motor mounting platform.

11. The motor mounting platform of claim 9, wherein the motor mounting platform is not in electrical contact with any current carrying component when the motor is attached to the at least one motor support.
